(19) United States
(12) Patent Application Publication
(10) Pub. No.: US 2013/0250603 A1
(43) Pub. Date: Sep. 26, 2013

(54) ILLUMINATION METHOD AND SYSTEM FOR A BAG

(71) Applicant: JOANEL INC., Laval (CA)

(72) Inventors: Aldjia BEGRICHE, Montreal (CA); Olivier VERMEERSCH, Saint-Hyacinthe (CA)

(73) Assignee: JOANEL INC., Laval (CA)

(21) Appl. No.: 13/799,579

(22) Filed: Mar. 13, 2013

Related U.S. Application Data
(60) Provisional application No. 61/613,664, filed on Mar. 21, 2012.

(51) Int. Cl. F21V 33/00; F21V 21/14; F21V 8/00

(52) U.S. Cl. CPC F21V 33/0004; G02B 6/0005; F21V 21/14
USPC 362/554; 362/249.12; 362/249.05; 362/225; 362/249.08

(57) ABSTRACT

A method and a system for illumination of a personal item, the system comprising at least one light source activated by a textile switch, the light source and the textile switch being secured to a textile substrate and connected by conductors on the textile substrate, the textile substrate being secured on the personal item. The method comprises securing at least one light source and a textile switch on a substrate, connecting the light source and the textile switch by conductors on the substrate, connecting the light source and the textile switch to a powering unit, securing the substrate to the personal item and operating the textile switch.

### CROSS REFERENCE TO RELATED APPLICATIONS

This application claims benefit of U.S. provisional application Ser. No. 61/613,664, filed on Mar. 21, 2012. All documents above are incorporated herein in their entirety by reference.

### FIELD OF THE INVENTION

The present invention relates to an illumination method and system for a personal item.

### SUMMARY OF THE INVENTION

More specifically, in accordance with the present invention, there is provided an illumination system for a personal item, comprising at least one light source activated by a textile switch, the light source and the textile switch being secured to a textile substrate and connected by conductors on the textile substrate, the textile substrate being secured on the personal item.

There is further provided a personal item comprising at least one light source activated by a textile switch, the light source and the textile switch being secured to a textile substrate and connected by conductors on the textile substrate.

There is further provided a method for illuminating a personal item, comprising securing at least one light source and a textile switch on a substrate, connecting the light source and the textile switch by conductors on the substrate, connecting the light source and the textile switch to a powering unit, securing the substrate to the personal item and operating the textile switch.

### BRIEF DESCRIPTION OF THE DRAWINGS

In the appended drawings:

FIG. 1 shows a partial view of system of according to an embodiment of an aspect of the present invention;

FIG. 2 shows light sources in a lighting unit of a system according to an embodiment of an aspect of the present invention;

FIG. 3 show a) light emitting diodes secured to a textile substrate on an inner surface of a liner inside a carrying item; b) conductors on the textile substrate on the inner surface of a liner inside a carrying item; c) the textile substrate on the inner surface of a liner inside a carrying item; and d) light emitting diodes as seen from outside of the carrying item, according to an embodiment of an aspect of the present invention;

FIG. 4 show a) conductive fabric surfaces of a switch; b) a conductive fabric surface of a switch; c) a hole in a conductive fabric surface; d) a conductive fabric surface with a hole; and e) conductive fabric surfaces of FIG. 4d in an exploded view, according to an embodiment of an aspect of the present invention;

FIG. 5 show a) a power and control unit, and b) a board, c) a battery, d) a battery holder; and e) connection of a power and control unit according to an embodiment of an aspect of the present invention;

FIG. 6 shows a part of a liner of a carrying item according to an embodiment of an aspect of the present invention;

FIG. 7 shows a part of a liner of a carrying item according to an embodiment of an aspect of the present invention;

FIG. 8 show a) a first side and b) an opposite side, of a pocket according to an embodiment of an aspect of the present invention;

FIG. 9 shows the pocket of FIG. 8 on a liner of a carrying item according to an embodiment of an aspect of the present invention;

FIG. 10 is a top view of FIGS. 9; and

FIG. 11 shows a carrying item according to an embodiment of an aspect of the present invention.

### DESCRIPTION OF EMBODIMENTS OF THE INVENTION

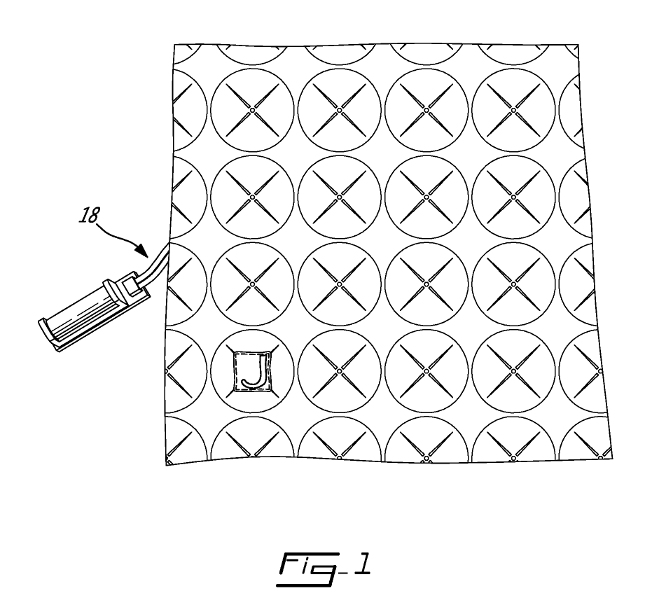

In an embodiment of an aspect of the present invention, a system comprises a lightning unit, a switch, and a power and control unit (see FIG. 1).

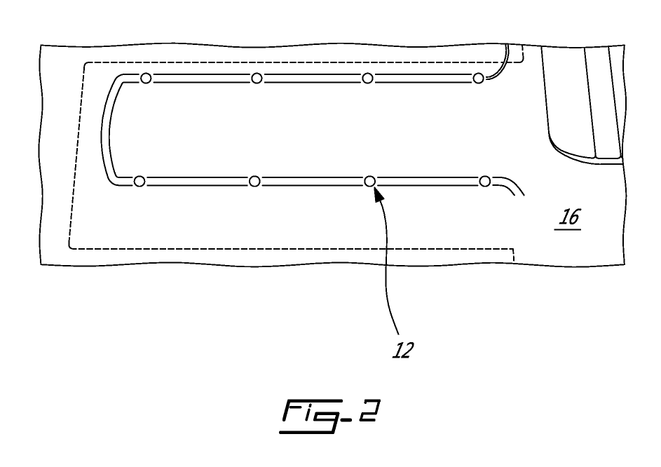

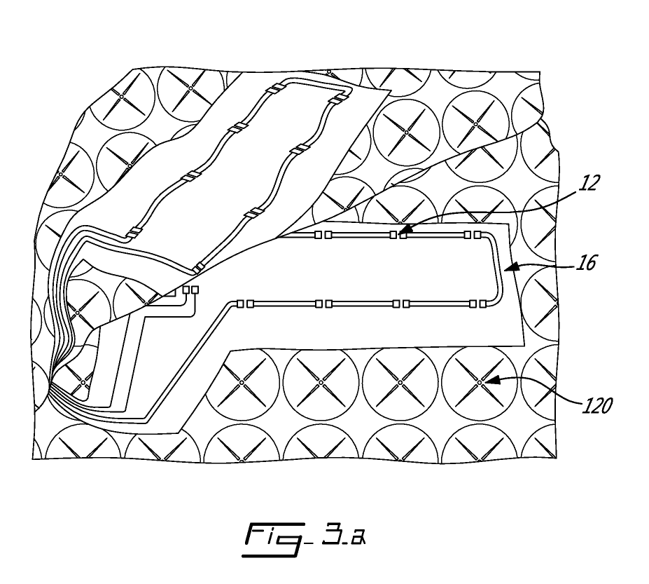

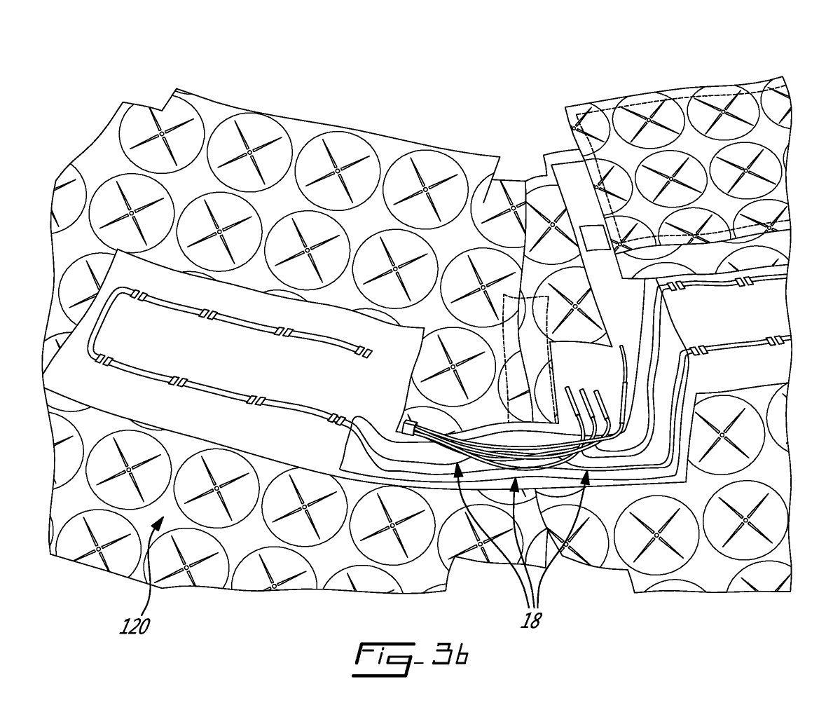

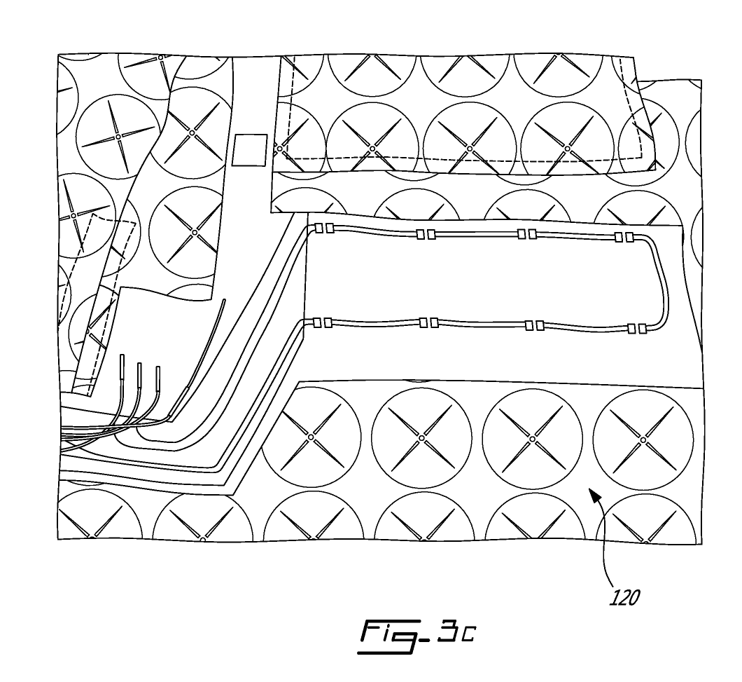

As shown for example in FIGS. 2 and 3, the lightning unit comprises light sources 12. The light sources 12 may be light emitting diodes (LEDs), for example, secured to a textile substrate 16 and connected by flexible conductors 18. Other light sources, such as small bulbs, electroluminescent strips or optical fibers for example, may be used. The light sources are typically selected so as to be of reduced size and volume.

The textile substrate 16 is a flexible material, such as a flexible cloth material, formed of textile fiber, wire, or other material and including any pliant fabric, woven, knit, felted, needled, or otherwise formed, of natural or synthetic filaments or films.

The flexible conductors 18 are metallic wires, for example silver, copper or stainless steel wires. Depending on the selected light sources and on the required current, other conductors, such as polymeric or carbonated, may be used. Alternatively, a metallic tape secured on the substrate 16 could be used, or conductors could be printed, by ink jet printing, flexography, screen printing etc. . . . with conductive inks.

The substrate 16 may be secured on an inner surface (non-visible) of a liner 120 of the carrying items for example. The position of the LEDs 12 may be adapted, depending on the design of the liner 120, so as to optimize, or vary, the illuminating effect (see FIG. 1). In the example of FIG. 3d for example, the LEDS 12 are positioned at the center of rosettes of the design of the liner 120, which happens to be of a lighter color, i.e. more light transmitting, than the remaining of the liner 120.

Tests show that the LEDS 12, substrate 16 and conductors 18 are operational, i.e. provide sufficient illumination, over a range of temperatures, for example between −25° C. and +50° C.

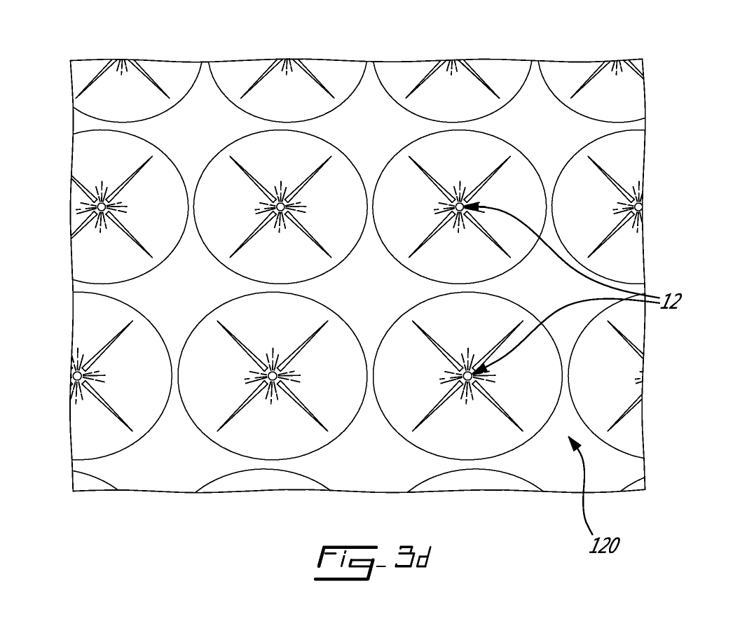

As shown in FIGS. 4 for example, a switch of the resistive type comprises two conductive fabric surfaces 15 separated by an insulating fabric 11, typically with a good resistance to compression (see FIGS. 4c-4e) provided with an aperture 13. The two conductive fabric surfaces 15 may be formed by embroidery, on the substrate 16, of conducting yarns, such as silver plated nylon yarns for example for example. They may also be formed by conductive tapes, conductive fabrics etc. . . . They may also be printed by ink jet printing, flexography, screen printing etc. . . . , with conductive inks. The two conductive fabric surfaces 15 are brought into electric contact only when a sufficient pressure is applied on the assembly, mainly through the aperture 13 in the sandwiched insulating fabric 11.

Tests have shown that such a switch is still operational, i.e. the two conductive fabric surfaces 15 are still able to brought into electric contact and separated, after a pressure of about 900 g on a surface of about 1 inch by 1 inch to simulate the pressure applied by a finger, submitted during more than 100 hours. Power supply to the switch is provided by conductive wires 18.

It was found that an electric resistance between the two conductive fabric surfaces 15 of the textile switch lower that 10 kohms allows lightening the diodes for a duration of 60 s under normal conditions of use, i.e. under an average pressure submitted to the textile switch.

The switch may be coated with a bright embroidery made for example with electroluminescent thread or wire, phosphorescent thread or wire or optic fibers, thereby easily noticeable within the inside of the carrying item, so that the user easily finds it for activation when needed.

A touch switch, i.e. a switch of the capacitive type, may also be used.

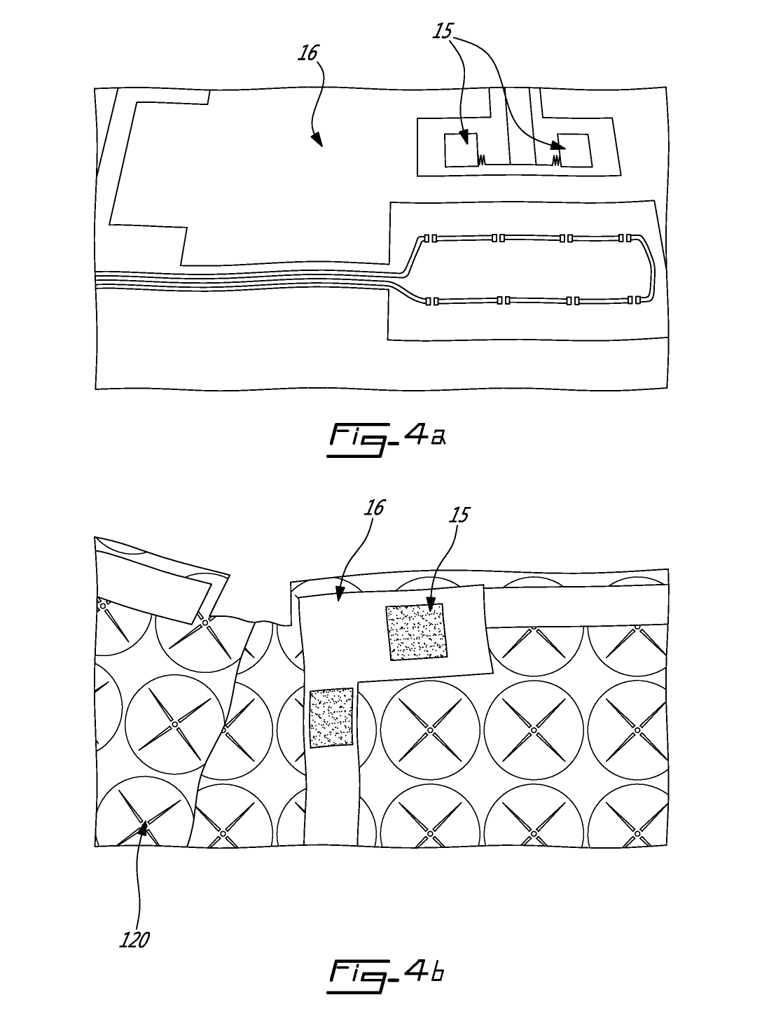

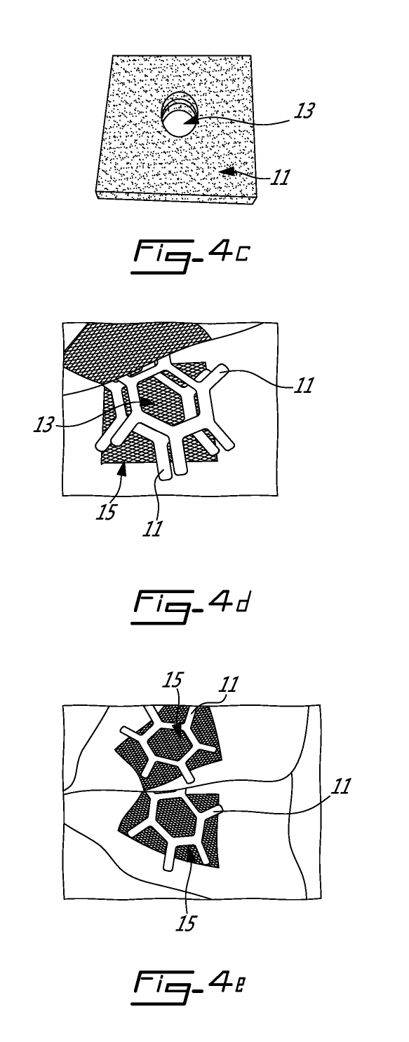

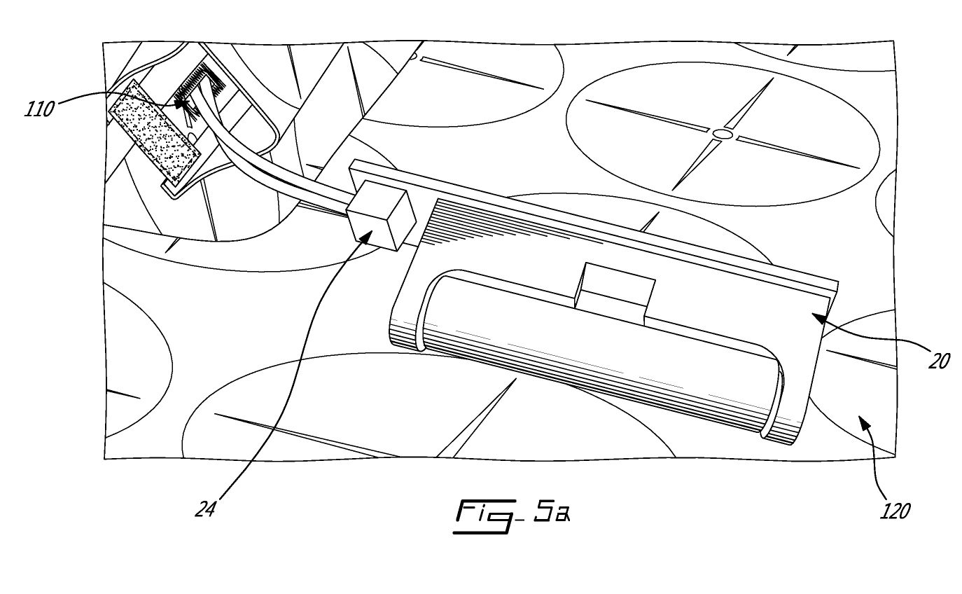

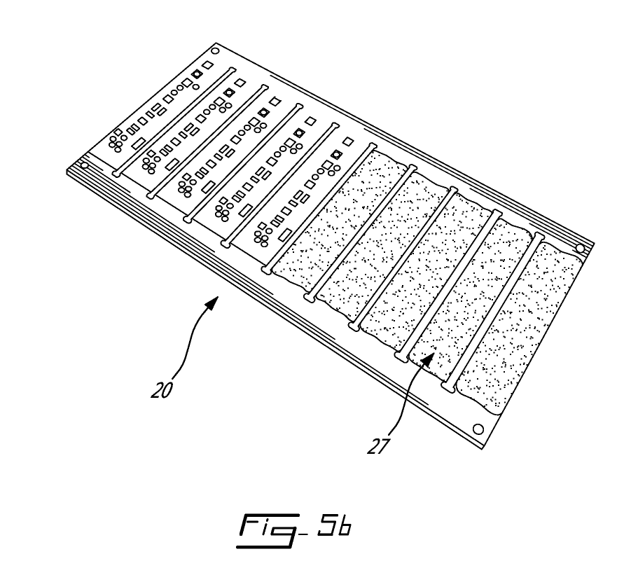

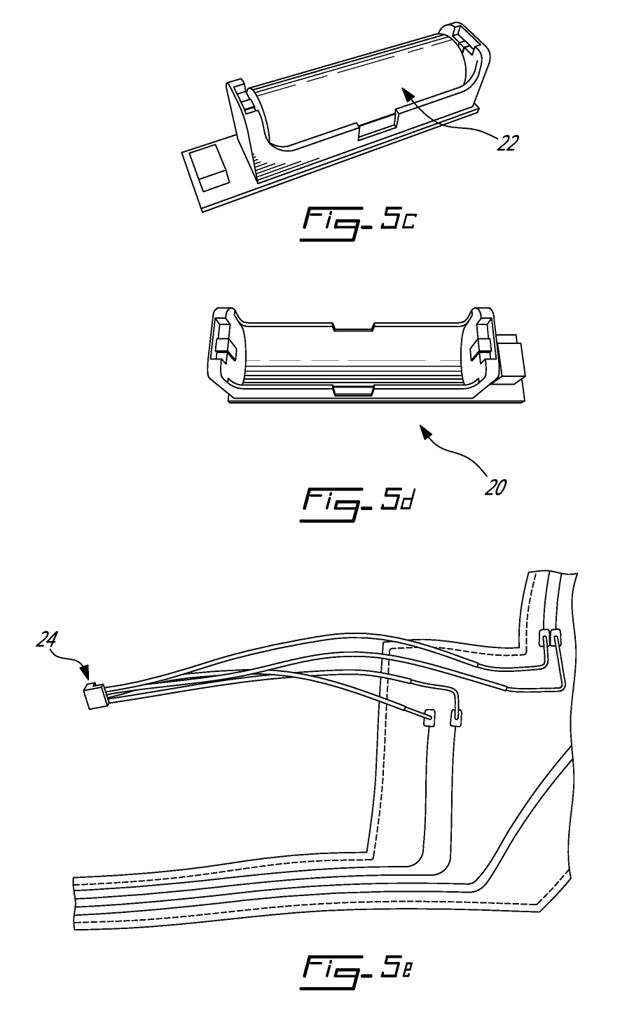

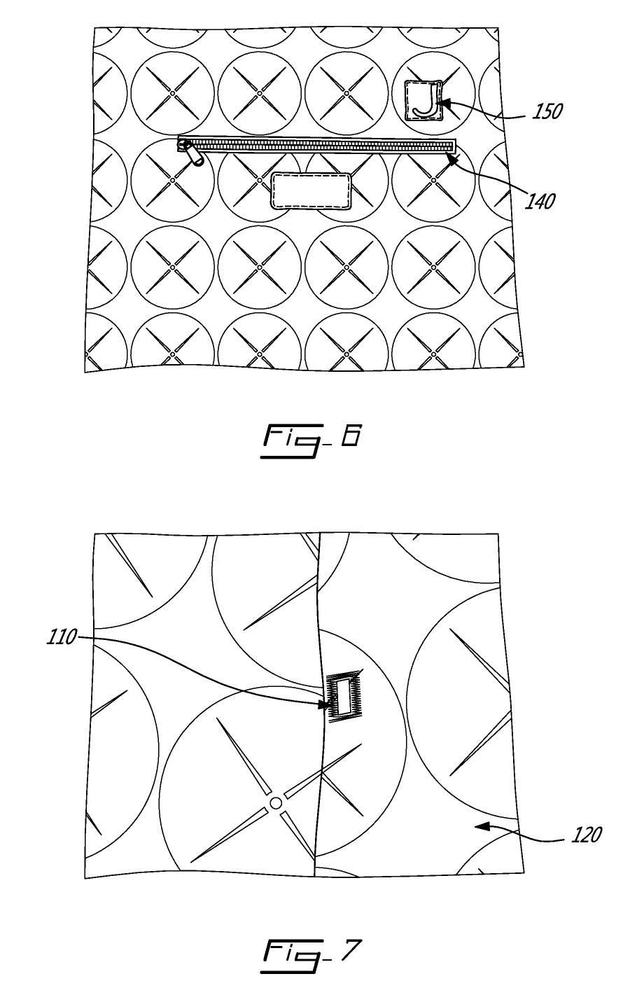

As illustrated in FIGS. 5, the power and control unit (FIG. 5a) typically comprises an electronic board 20 (FIG. 5b) and batteries 22 (FIG. 5c) supported by a holder (FIG. 5d). A shown in FIG. 5b, a coating 27 may be applied on the board to prevent access to its active components The power and control unit is removably connected to the textile substrate 16 by a connecter 24 (FIG. 5e). It is typically located inside the personal item, in an inner pocket for example as will be described in relation to FIG. 7 hereinbelow, so as to be removable or at least to allow access to the batteries 22. It may further comprise a time switch allowing switching off the light sources 12 a predetermined amount of time after they have been activated by action on the switch.

Flexible conductors 18 connect the light sources 12 and the textile switch 14 on the substrate 16 and to the power and control unit (see FIG. 1).

In the example illustrated in FIG. 6, the switch is positioned, on the inner liner 120 inside the personal item, above an inside pocket 140 of the carrying item (see FIG. 4b). Basically, the switch, although not visible in the personal item, is thus easily located and reachable by the user. The location of the switch 14 may be indicated on the inner liner 120 by a specific ornamentation 150, above the opening of the pocket 140 for example (see FIG. 6), thereby allowing easy activation by the user when needed. On the non-visible surface of the inner liner 120, the LEDs 12 are positioned on a substrate 16, as well as conductive wires 18 connecting the locations of the LEDS to the pocket 130 and the switch 14 as described hereinabove.

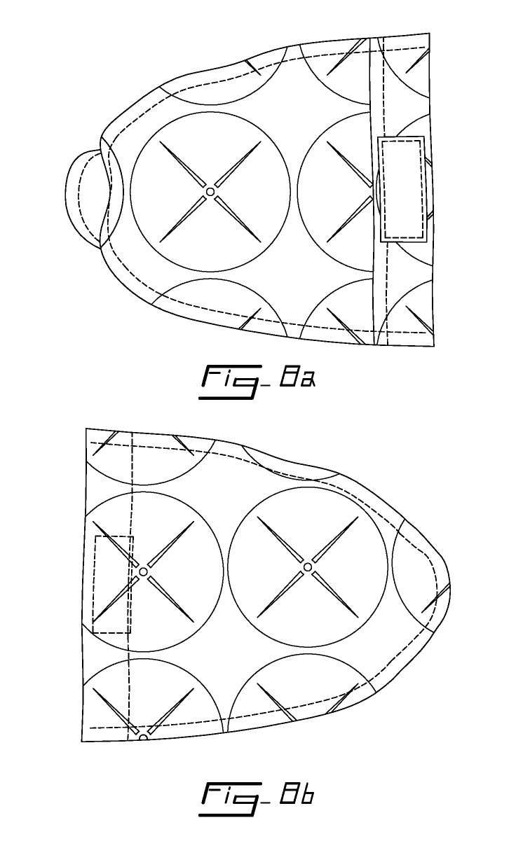

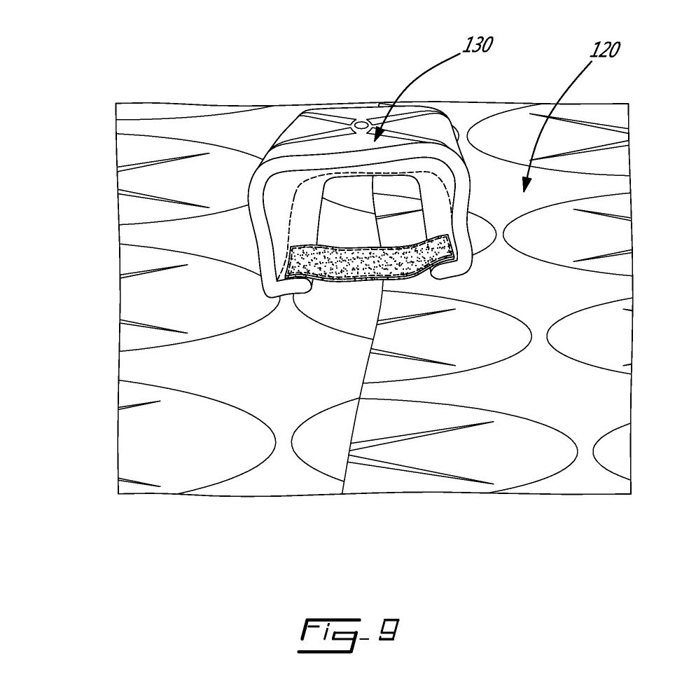

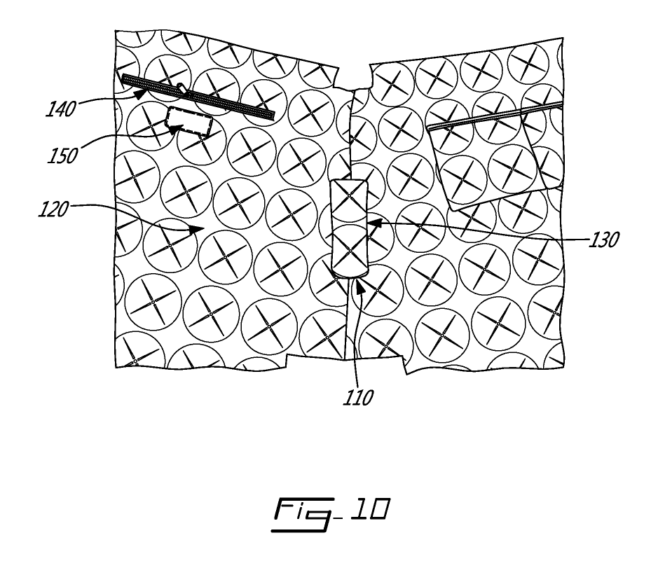

As illustrated in FIG. 7, a button hole 110 is made in the liner 120 of the personal item. A pocket 130, shown for example in FIG. 7, is secured to the liner 120, by sewing for example (see FIG. 9), above the button hole 110 (see FIG. 10), which allows passing connectors from the pocket 130 inside the liner 120. The pocket 130 houses the power and control unit.

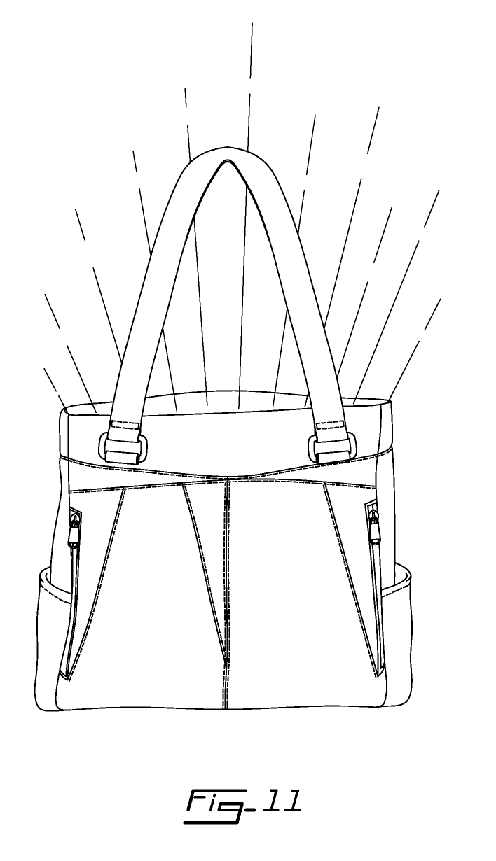

When integrated within the inner liner of a personal item such as a hand bag, a knapsack, a purse, a wallet, a spectacle case etc. . . . for example, the present system provides sufficient light to illuminate at least part of the inside of the carrying item while remaining unnoticeable and most discrete (see FIG. 11). The present system may also be used to illuminate the outside of a personal item.

The scope of the claims should not be limited by the preferred embodiments set forth in the examples, but should be given the broadest interpretation consistent with the description as a whole.

What is claimed is:

1. Illumination system for a personal item, comprising at least one light source activated by a textile switch, said light source and said textile switch being secured to a textile substrate and connected by conductors on the textile substrate, said textile substrate being secured on the personal item.

2. The system of claim 1, wherein said light source comprise at least one light emitting diode.

3. The system of claim 1, wherein said light source comprises at least one of: light emitting diodes, bulbs, electroluminescent strips and optical fibers.

4. The system of claim 1, wherein said textile substrate is a flexible cloth material.

5. The system of claim 1, wherein said textile substrate is one of: flexible a polymer material and a composite material.

6. The system of claim 1, wherein said conductors are metallic wires.

7. The system of claim 1, wherein said conductors are ones of: metallic wires, polymeric wires and carbonated wires.

8. The system of claim 1, wherein said conductors comprise at least one metallic tape secured on said substrate.

9. The system of claim 1, wherein said conductors are conductors printed on said substrate.

10. The system of claim 1, wherein said textile switch comprises two conductive fabric surfaces separated by an insulating fabric.

11. The system of claim 1, wherein said textile switch comprises conductive fabric surfaces formed by embroidery of conducting yarns on said substrate, said conductive fabric surfaces being separated by an insulating fabric.

12. The system of claim 1, wherein said textile switch comprises conductive fabric surfaces formed by ones of: conductive tapes and conductive fabrics on said substrate, said conductive fabric surfaces being separated by an insulating fabric.

13. The system of claim 1, wherein said textile switch comprises conductive fabric surfaces printed on said substrate and separated by an insulating fabric.

14. The system of claim 1, wherein said textile switch comprises embroidery.

15. The system of claim 1, wherein said textile switch is a touch switch.

16. The system of claim 1, further comprising a power and control unit connected to said textile substrate.

17. The system of claim 1, further comprising a power and control unit connected to said textile substrate and located in said personal item.

18. The system of claim 1, further comprising a power and control unit connected to said textile substrate, said power and control unit including a time switch allowing switching off said light source a predetermined amount of time after said light source has been activated by operation of said textile switch.

19. A personal item comprising at least one light source activated by a textile switch, said light source and said textile switch being secured to a textile substrate and connected by conductors on the textile substrate.

20. The personal item of claim 19, wherein said light source comprises at least one of: light emitting diodes, bulbs, electroluminescent strips and optical fibers.

21. The system of claim 19, wherein said textile substrate is one of: a cloth material, a polymer material and a composite material.

22. The system of claim 19, wherein said conductors are ones of: metallic wires, polymeric wires, carbonated wires, metallic tapes secured on said substrate and conductors printed on said substrate.

23. The system of claim 19, wherein said textile switch comprises two conductive fabric surfaces separated by an insulating fabric.

24. The system of claim 19, wherein said textile switch is a touch switch.

25. The system of claim 19, further comprising a power and control unit connected to said textile substrate.

26. A method for illuminating a personal item, comprising:
securing at least one light source and a textile switch on a substrate;
connecting the light source and the textile switch by conductors on the substrate;
connecting the light source and the textile switch to a powering unit;
securing the substrate to the personal item; and
operating the textile switch.
